(19) United States
(12) Patent Application Publication
(10) Pub. No.: US 2026/0286612 A1
(43) Pub. Date: Sep. 24, 2026

(54) A paperboard structure comprising a barrier coating layer

(71) Applicant: Metsä Board Oyj, Metsä (FI)

(72) Inventors: Henri Kastinen, Metsä (FI); Riku Talja, Metsä (FI); Lauri Verkasalo, Metsä (FI); Minna Hakalahti, Metsä (FI); Kirsi Hirvonen, Metsä (FI); Terhi Saari, Metsä (FI); Karoliina Helanto, Metsä (FI)

(21) Appl. No.: 19/490,967

(22) PCT Filed: Jun. 27, 2024
(86) PCT No.: PCT/FI2024/050357

§ 371 Date: Dec. 8, 2025

(30) Foreign Application Priority Data
Jun. 30, 2023 (FI) 20235770

(51) Int. Cl. D21H 19/28; C09D 167/02; C09D 167/04; D21H 19/34; D21H 19/80

(52) U.S. Cl. CPC D21H 19/28; C09D 167/02; C09D 167/04; D21H 19/34; D21H 19/80

(57) ABSTRACT

According to an example aspect of the present invention, there is provided a paperboard structure, comprising a paperboard substrate and a barrier coating layer on the paperboard substrate, wherein the paperboard substrate comprises folding boxboard or linerboard, wherein the barrier coating layer comprises microcrystalline cellulose and a polyester derived from succinic acid and/or adipic acid, wherein the average particle size of the microcrystalline cellulose ranges from 1 μm to less than 20 μm, wherein the barrier coating layer has been prepared by extruding a composition comprising microcrystalline cellulose and said polyester on the paperboard substrate.

### FIELD

The present disclosure belongs to the field of paperboard products. More specifically, it belongs to the field of barrier coated paperboard structures formed by extrusion coating.

### BACKGROUND

Extrusion coating is a process where a thin layer of coating composition is extruded on to a substrate, such as paper, paperboard, metal or plastic. Typically, the extrusion coating composition is based on polymers, such as low-density polyethylene (LDPE). It would however be important to replace plastic components with bio-based solutions.

Cellulose-based components could serve as potential coating components. One issue with cellulose-based components is that they cannot be readily mixed with typical coating polymers because the surface chemistries of the two components are not compatible. Therefore, cellulose-based materials do not mix/disperse well in polymer matrixes. In addition, cellulose based materials in some cases have poor adhesion to surface of a polymer. Typically, these issues are alleviated by using additives or by treating the surface of the cellulose based components.

Extrusion coating sets requirements on the used composition that make only certain polymers or compositions suitable for extrusion. At high extrusion coating speed, even a minor disturbance on the melt web causes major quality problems that can very rapidly lead to large quantities of waste. Neck-in is another common issue in extrusion coating. Therefore, polymers are required with high and consistent quality to avoid waste due to polymer edge instability and web breaks. Compositions used for extrusion coating must further adhere to the surface to be coated. Further, the composition must be heat-resistant because extrusion requires use of high temperatures. Such requirements are not present for example in spray coating.

### SUMMARY OF THE INVENTION

The invention is defined by the features of the independent claims. Some specific embodiments are defined in the dependent claims.

According to the first aspect of the present invention, there is provided a paperboard structure, comprising a paperboard substrate and a barrier coating layer on the paperboard substrate. The paperboard substrate comprises folding boxboard or linerboard. The barrier coating layer comprises microcrystalline cellulose and a polyester derived from succinic acid and/or adipic acid, and the average particle size of the microcrystalline cellulose ranges from 1 μm to less than 20 μm. The barrier coating layer has been prepared by extruding a composition comprising microcrystalline cellulose and said polyester on the paperboard substrate.

According to the second aspect of the present invention, there is provided a method of coating. The method comprises melting a composition comprising microcrystalline cellulose and a polyester derived from succinic acid and/or adipic acid, and extruding the melted composition onto a paperboard substrate to form a barrier coating layer on the paperboard substrate. The paperboard substrate comprises folding boxboard or linerboard, and the average particle size of the microcrystalline cellulose ranges from 1 μm to less than 20 μm.

According to the third aspect of the present invention, there is provided use of a polyester derived from succinic acid and/or adipic acid in an extrusion coated layer on a folding boxboard substrate or a linerboard substrate.

According to the fourth aspect of the present invention, there is provided use of a polyester derived from succinic acid and/or adipic acid in an extrusion coated layer on a linerboard substrate.

Various embodiments of the first aspect or the second aspect or the third aspect or the fourth aspect may comprise one or more features from the following bulleted list:
The polyester is selected from the following group: polybutylene succinate (PBS), polyethylene succinate (PES), polypropylene succinate (PPS), polybutylene adipate (PBA), polybutylene succinate-co-adipate (PBSA), polybutylene adipate-co-terephthalate (PBAT), and any co-polymers and mixtures thereof.
The polyester is selected from polybutylene succinate and polybutylene adipate or combinations thereof
The polyester comprises polybutylene succinate and/or polybutylene succinate co-adipate.
The polyester comprises polybutylene adipate and/or polybutylene adipate-co-terephthalate.
The composition comprises at least 50 wt-%, for example at least 70 wt-%, of said polyester, calculated from the total weight of the composition.
The average particle size of the microcrystalline cellulose is in the range 1 μm to less than 20 μm.
The microcrystalline cellulose has been prepared from wood, such as wood pulp.
The composition comprises a homogeneous dispersion of microcrystalline cellulose particles in a polyester matrix or a polyester medium.
The barrier coating layer comprises at least 10 wt-% of microcrystalline cellulose, such as at least 20 wt-%, for example at least 30 wt-%, calculated from the total weight of the barrier coating layer.
During said extruding, the temperature of the melted composition is at least 150° C., such as at least 200° C.
The thickness of the extruded barrier coating layer is in the range of 1 to 50 μm.
The coating layer is a barrier coating layer.
The barrier coating layer provides one or more of the following: oil resistance, grease resistance, moisture resistance, water vapour resistance, gas resistance, flavour resistance, oxygen resistance.
The paperboard substrate comprises folding boxboard.
The paperboard substrate comprises linerboard.
The barrier coating layer comprises at least 10 wt-% of microcrystalline cellulose and at least 50 wt-% of polybutylene succinate, polybutylene adipate or combinations thereof calculated from the total weight of the barrier coating layer.
The barrier coating layer comprises at least 20 wt-% of microcrystalline cellulose and at least 70 wt-% of polybutylene succinate, polybutylene adipate or combinations thereof calculated from the total weight of the barrier coating layer.
The barrier coating layer consists of microcrystalline cellulose and a polyester derived from succinic acid and/or adipic acid.
The paper board structure comprises at least one coating layer in addition to the barrier coating layer.
20. The method according to any of claims 11 to 19, wherein the melt index of the barrier coating layer is below 30 g/10 min.
The extrusion is performed on a moving web.

### Advantages of the Invention

An advantage of the present invention is that it may provide a biodegradable paperboard structure.

Another advantage of the present invention is that it may provide a barrier coating composition suitable for extrusion coating.

Another advantage of the present invention is that the microcrystal cellulose particles may create discontinuity in the polyester matrix making recycling of the formed barrier coating layer easier.

### BRIEF DESCRIPTION OF THE DRAWINGS

FIG. 1 illustrates a compounding process. On the left, Ecovio with 20 wt-% of microcrystalline cellulose of the total weight of the composition. On the right, PBSA with 30 wt-% microcrystalline cellulose of the total weight of the composition.

FIG. 2 illustrates films formed with an extrusion process. On the left, LDPE with 10 wt-% of microcrystalline cellulose of the total weight of the composition. On the right, PBSA with 30 wt-% microcrystalline cellulose of the total weight of the composition.

### EMBODIMENTS

### Definitions

Unless otherwise stated herein or clear from the context, any percentages referred to herein are expressed as percent by weight based on a total weight of the respective composition.

Unless otherwise stated, properties that have been experimentally measured or determined herein have been measured or determined at room temperature. Unless otherwise indicated, room temperature is 25° C.

Unless otherwise stated, properties that have been experimentally measured or determined herein have been measured or determined at atmospheric pressure.

As used herein, the term “about” refers to a value which is ±5% of the stated value.

In the present context, the term “microcrystalline cellulose”, also referred to as “MCC”, refers to a product derived from cellulose that mainly comprises crystalline aggregates. MCC is purified and partially depolymerized cellulose, preferably prepared from plant material such as wood pulp. MCC may be produced from wood or from non-wood materials. MCC is also sometimes referred to with the name cellulose microcrystal. MCC may be powdered or colloidal.

In the present context, the term “extrusion coating” refers to process where substrate is coated with a resin material by extruding the resin material onto a moving substrate through a flat die. The material exits the die typically at a high temperature. The temperature may be for example 150 to 400° C. typically between 200 to 350° C. When the melt exits the die, the melt film is pulled down into a nip formed by two rollers, the pressure roller and the chill roll from where it is forced on to a moving substrate by the pressure between the two rolls. The velocity of the substrate is higher than that of the melt film. In a typical extrusion process, the substrate is passed at a high velocity, typically above 100 m/min, for example above 200 m/min or up to 1000 m/min.

As used herein, the term “average particle size” refers to the D₅₀ value of the cumulative volume distribution curve at which 50% by volume of the particles have a diameter less than that value.

As used herein, the term “polymer” describes an organic substance composed of a plurality of repeating structural units (backbone units) covalently connected to one another. The term “polymer” as used herein encompasses organic and inorganic polymers and further encompasses one or more of a homopolymer, a copolymer or a mixture thereof (a blend). The term “homopolymer” as used herein describes a polymer that is made up of one type of monomeric units and hence is composed of homogenic backbone units. The term “co-polymer” as used herein describes a polymer that is made up of more than one type of monomeric units and hence is composed of heterogenic backbone units. The heterogenic backbone units can differ from one another by the pendant groups thereof.

In the present context, the term “barrier coating” refers to a coating composition or a layer formed by the composition, which provides barrier effects. Such barrier effects may include for example oil resistance, grease resistance, moisture resistance, water vapour resistance, gas resistance, flavour resistance and/or oxygen resistance. In some preferred embodiments, the barrier effect is selected from water vapour resistance or moisture resistance. In other embodiments, the barrier effect may refer to oil resistance.

The present disclosure describes a paperboard structure that comprises a paperboard substrate and a barrier coating layer on the paperboard substrate. The barrier coating layer comprises cellulose-based materials that may be dispersed in a polyester. The paperboard substrate may comprise folding boxboard or linerboard. The barrier coating layer may comprise microcrystalline cellulose and a polyester derived from succinic acid and/or adipic acid. The average particle size of the microcrystalline cellulose may range from 1 μm to less than 20 μm. The barrier coating layer may be prepared by extruding a composition comprising microcrystalline cellulose and said polyester on the paperboard substrate.

Importantly, the composition of the invention is suitable for extrusion coating. Extrusion coating requires for example that the melt flow index of the material is at certain level so that extrusion is possible and that the formed coating layer has sufficient adhesion to the paperboard substrate. Further, particles in extrusion coatings increase the amount of potential nucleation centres, which increases the risk that the extruded coating layer becomes brittle and has unwanted appearance. Thus, compositions comprising particles are not obvious for use in extrusion coating.

Microcrystalline cellulose particles with average particle size of 1 to 20 μm differ from larger microcrystalline cellulose particles in that they have a larger specific surface-area, which may affect for example the adhesion of the formed barrier coating layer on a paperboard substrate, and melt flow index of the barrier coating layer. In addition, the size of MCC particles may affect appearance of a coated paperboard substrate and the roughness of the surface. Both factors are important points to consider when producing paperboard products.

The polyester in the composition may be any polyester derived from succinic acid and/or adipic acid. In some embodiments, the polyester comprises one or more of the following group: polybutylene succinate (PBS), polyethylene succinate (PES), polypropylene succinate (PPS), polybutylene adipate (PBA) and polybutylene succinate-co-adipate (PBSA), polybutylene adipate-co-terephthalate (PBAT), and any co-polymers and mixtures thereof. In some preferred embodiments, the polymer may be selected from polybutylene succinate and polybutylene adipate or combinations thereof.

In some embodiments, the barrier coating layer may comprise at least 50 wt-% of said polyester calculated from the total weight of the layer. In some preferred embodiment, the barrier coating layer may comprise at least 60 wt-% or at least 70 wt-% of the polyester calculated from the total weight of the layer. The barrier coating layer may comprise for example at least 80 wt-%, at least 85 wt-% or at least 90 wt-% of the polyester calculated from the total weight of the layer.

The MCC content of the composition may vary. In some embodiments, the MCC content may vary for example in the range of 5 to 60 wt-% calculated from the total mass of the composition. In some embodiments, the composition comprises at least 10 wt-% of microcrystalline cellulose calculated from the total mass of the composition. In other embodiments, the composition comprises at least 20 wt-% of microcrystalline cellulose calculated from the total mass of the composition. Preferably, the composition comprises at least 30 wt-% of microcrystalline cellulose calculated from the total mass of the composition. In some embodiments, the microcrystalline cellulose may be prepared from wood, such as wood pulp.

The composition comprising microcrystalline cellulose and said polyester may in some embodiments be used without additional additives. The composition may consist of microcrystalline cellulose and said polyester.

In other embodiments, the composition may further comprise additives. Such additives may comprise for example binders, pigments, thermal stabilizers, antistatics and/or compatibilizers. The inventors have however observed that the composition disclosed herein is such that it may form a homogenous mixture without additives. Specifically, microcrystalline cellulose may be dispersed into a polyester matrix derived from succinic acid and/or adipic acid. It may be that the chemical characteristics of the surface of MCC particles and succinic acid and/or adipic acid based polyesters are more compatible than that of MCC and other types of polymers. Therefore, additives are not needed for forming a dispersion of MCC and succinic acid and/or adipic acid based polymers. In some embodiments, the MCC particles in the composition distribute homogenously to the polyester. Homogenous distribution may be important for the coating composition because it may result in better performance during extrusion. Further, it may provide even barrier effects throughout the coated paperboard structure.

In some embodiments, MCC particles may replace or reduce the use of pigments, such as talc, kaolin and calcium carbonate, as fillers in polyester matrixes. Pigments tent to damage extruders over time. MCC particles are softer than the metal parts of an extruder and therefore MCC particles may impose less damage to the machine.

In some embodiments, the barrier coating layer has preferably a thickness in the range of 1 to 200 μm, more preferably 1 to 100 μm, most preferably 1 to 50 μm. In some embodiments, the thickness of the barrier coating layer is from 1 to 20 μm, such as from 1 to 8 μm, for example about 5 μm. The thickness of the barrier coating layer is typically limited by the size of the microcrystalline cellulose particles. A thin layer is preferable, because it leads to lower material consumption.

In some embodiments, the paperboard structure may comprise at least one coating layer in addition to the barrier coating layer. Such additional coating layer may be for example a pre-coating, a further barrier coating, such as dispersion barrier coating, or a top-coating. For example, the additional coating layer may comprise at least one pigment such as talc, calcium carbonate, clay, bentonite, montmorillonite or chemically modified pigments, and/or at least one binder, such as cellulose and cellulose derivatives, starch and starch derivatives, hemicellulose and hemicellulose derivatives and/or synthetic binders such as styreneacrylate, styrene-butadiene, acrylate copolymers, ethylacrylate, polyolefins, polyvinylacetate and polyvinylalcohol. The additional coating layer may in other embodiments comprise at least one primer. In some examples, the additional coating layer may comprise 60 wt-% of pigment and 40 wt-% of binder, such as a biobinder. In other examples, the paperboard structure may comprise multiple additional coating layers. For example, the paperboard structure may comprise a pre-coating and a top-coating. In some embodiments, the pre-coating may be denser than the top-coating. The fibrous product may for example be coated prior to application of the composition.

The paperboard structure of the present invention may be formed by extrusion coating. Extrusion coating sets certain requirements for the composition that is extruded on the paperboard structure. The composition disclosed herein is suitable for extrusion coating. In some embodiments, the composition may be resistant to elevated temperatures. The composition may be extruded for example at a temperature over 100° C., such as over 150° C. In such temperatures, the composition in some embodiments may be completely in a molten state. In other embodiments, the composition is not cured or burned at the elevated temperature.

Flow rate of the polymer melt is affected for example by polymer viscosity, screw speed, and the geometry of screw and die. The composition disclosed herein exhibits good mechanical properties, which allow formation of a continuous web during extrusion. Mechanical properties may include for example stretch properties, melt viscosity and/or melt index. Melt index (also known as melt flow index, MFI) is a measure of the case of flow of melt of a thermoplastic polymer. Typically, melt index is determined by using a procedure according to ISO standard 1133-1 (2022). In some embodiments, melt index of the disclosed composition may be for example below 30 g/10 min, such as below 20 g/10 min. In other embodiments, melt index of the disclosed composition may be for example below 30 g/10 min at 250° C., such as below 20 g/10 min at 250° C. In other embodiments, MCC particles improve melt flow index of the polyester. Improved melt flow index allows application of thinner coating layer.

In other embodiments, a method of coating is disclosed. The method may comprise the steps of a) melting a composition comprising microcrystalline cellulose and a polyester derived from succinic acid and/or adipic acid, and b) extruding the melted composition onto a paperboard substrate to form a barrier coating layer on the paperboard substrate. The paperboard substrate may comprise folding boxboard or linerboard. The average particle size of the microcrystalline cellulose may range from 1 μm to less than 20 μm. In some embodiments, the extrusion is performed onto a moving web.

In some embodiments, the polyester may comprise one or more of the polyesters selected from the following group: polybutylene succinate (PBS), poly ethylene succinate (PES), polypropylene succinate (PPS), polybutylene adipate (PBA) and polybutylene succinate-co-adipate (PBSA), polybutylene adipate-co-terephthalate (PBAT), and any co-polymers and mixtures thereof. In some preferred embodiments, the polyester is selected from polybutylene succinate or polybutylene adipate or combinations thereof. In other embodiments, the polyester may comprise polybutylene succinate or polybutylene succinate co-adipate. In some examples, the polyester may comprise polybutylene adipate or polybutylene adipate-co-terephthalate.

In some examples, the composition may comprise at least 50 wt-% of said polyester calculated from the total weight of the layer. In some preferred embodiment, the composition may comprise at least 60 wt-% or at least 70 wt-% of the polyester calculated from the total weight of the composition. The composition may comprise for example at least 80 wt-%, at least 85 wt-% or at least 90 wt-% of the polyester calculated from the total weight of the composition.

In other embodiments, the composition may comprise at least 10 wt-% of microcrystalline cellulose, such as at least 20 wt-%, for example at least 30 wt-%, calculated from the total mass of the composition. In some preferred embodiments, the microcrystalline cellulose may be prepared from wood, such as wood pulp.

In some embodiments, the barrier coating layer comprises at least 10 wt-% of microcrystalline cellulose and at least 50 wt-% of polybutylene succinate, polybutylene adipate or combinations thereof calculated from the total weight of the barrier coating layer. In other embodiments, the barrier coating layer comprises at least 20 wt-% of microcrystalline cellulose and at least 70 wt-% of polybutylene succinate, polybutylene adipate or combinations thereof calculated from the total weight of the barrier coating layer.

The thickness of the extruded barrier coating layer may be in the range of 0.5 to 200 μm, more preferably 1 to 100 μm, most preferably 1.5 to 50 μm. In some embodiments, the thickness of the layer is from 2 to 20 μm, such as from 2.5 to 8 μm, for example about 5 μm.

The temperature of the melted composition during the extruding step is elevated. In some embodiments, the temperature may be over 100° C., for example at least 150° C., such as at least 200° C.

In other embodiments, the use of a polyester derived from succinic acid and/or adipic acid in an extrusion-coated layer on a folding boxboard substrate is disclosed.

### EXAMPLE

Tested polymers included polybutylene succinate co-adipate (PBSA, Mitsubishi), low-density polyethylene (LDPE, Borealis) and a PLA-based polymer (Ecovio®, BASF). Each polymer was mixed with microcrystalline cellulose (MCC) in an amount of 10 wt-%, 20 wt-% or 30 wt-% of MCC calculated from the total weight of the mixture.

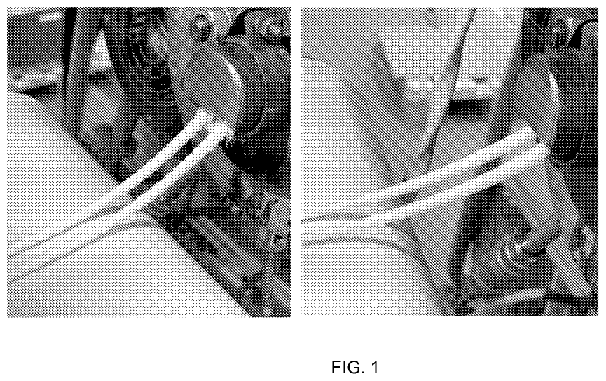

The mixtures were subjected to compounding process. Ecovio ad LDPE had “hairy” material coming out from the compounding extruder already in 10 wt-% MCC content. (FIG. 1, on the left-hand side). However, PBSA stayed smooth even at 30 wt-% MCC content (FIG. 1, on the right-hand side). Based on these results, the choice of the polymer is important for the structure of the composition. MCC mixed with PBSA provides smooth composition suitable for extrusion coating whereas MCC mixed with other tested polymers forms composition not suitable for extrusion coating.

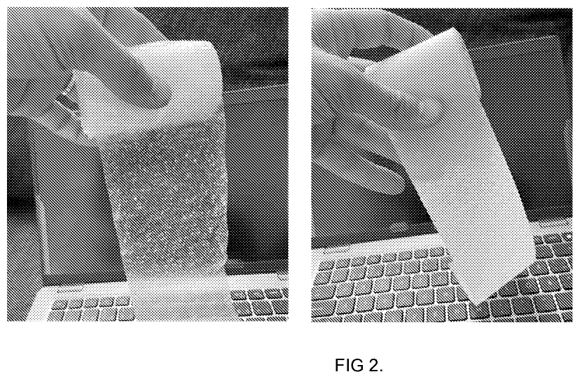

Films were extruded from the compounded materials. The average MCC particle size appeared to be important for film formation because thin films could not be achieved when the MCC particles were large. Ecovio and LDPE based materials performed poorly in the extrusion experiments. PBSA based compositions however produced films with good stretch properties. PBSA based compositions also had the best adhesion to paper out of the tested materials. Necking of these materials was not too severe. In addition, distribution of MCC particles was homogenous in PBSA but not in other tested polymers (FIG. 2).

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### ACRONYMS LIST

MCC microcrystalline cellulose
PBS polybutylene succinate
PES polyethylene succinate
PPS polypropylene succinate
PBA polybutylene adipate
PBSA polybutylene succinate-co-adipate
PBAT polybutylene adipate-co-terephthalate
PLA polylactic acid
LDPE low-density polyethylene

1. A paperboard structure, the paperboard structure comprising a paperboard substrate and a barrier coating layer on the paperboard substrate,
wherein the paperboard substrate comprises folding boxboard or linerboard,
wherein the barrier coating layer comprises microcrystalline cellulose and a polyester derived from succinic acid and/or adipic acid,
wherein the average particle size of the microcrystalline cellulose is from 1 μm to less than 20 μm, and
wherein the barrier coating layer is an extrusion composition comprising the microcrystalline cellulose and the polyester on the paperboard substrate.

2. The paperboard structure according to claim 1, wherein the polyester comprises one or more of the following group: polybutylene succinate (PBS), polyethylene succinate (PES), polypropylene succinate (PPS), polybutylene adipate (PBA) and polybutylene succinate-co-adipate (PBSA), polybutylene adipate-co-terephthalate (PBAT), and any co-polymers and mixtures thereof.

3. The paperboard structure according to claim 1, wherein the polyester is selected from polybutylene succinate and polybutylene adipate or combinations thereof.

4. The paperboard structure according to claim 1, wherein the barrier coating layer comprises at least 50 wt-% of said polyester, calculated from the total weight of the barrier coating layer.

5. The paperboard structure according to claim 1, wherein the barrier coating layer comprises at least 10 wt-% of the microcrystalline cellulose, calculated from the total weight of the barrier coating layer.

6. The paperboard structure according to claim 1, wherein the thickness of the barrier coating layer is 1 to 50 μm.

7. The paperboards structure according to claim 1, wherein the barrier coating layer comprises at least 10 wt-% of the microcrystalline cellulose and at least 50 wt-% of polybutylene succinate, polybutylene adipate or combinations thereof, calculated from the total weight of the barrier coating layer.

8-9. (canceled)

10. The paperboard structure according to claim 1, wherein the paperboard structure comprises at least one coating layer in addition to the barrier coating layer.

11. A method of coating, the method comprising:
melting a composition comprising microcrystalline cellulose and a polyester derived from succinic acid and/or adipic acid, and
extruding the melted composition onto a paperboard substrate to form a barrier coating layer on the paperboard substrate,
wherein the paperboard substrate comprises folding boxboard or linerboard, and
wherein the average particle size of the microcrystalline cellulose is from 1 μm to less than 20 μm.

12. The method according to claim 11, wherein the polyester comprises one or more of the following group: polybutylene succinate (PBS), polyethylene succinate (PES), polypropylene succinate (PPS), polybutylene adipate (PBA) and polybutylene succinate-co-adipate (PBSA), polybutylene adipate-co-terephthalate (PBAT), and any co-polymers and mixtures thereof.

13. The method according to claim 11, wherein the polyester comprises polybutylene succinate or polybutylene succinate co-adipate.

14. The method according to claim 11, wherein the polyester comprises polybutylene adipate or polybutylene adipate-co-terephthalate.

15. The method according to claim 11, wherein the composition comprises at least 50 wt-% of said polyester, calculated from the total weight of the composition.

16. The method according to claim 11, wherein the microcrystalline cellulose has been prepared from wood.

17. The method according to claim 11, wherein the composition comprises at least 10 wt-% of microcrystalline cellulose, calculated from the total weight of the composition.

18. The method according to claim 11, wherein during said extruding, the temperature of the melted composition is at least 150° C.

19. The method according to claim 11, wherein the thickness of the barrier coating layer is 1 to 50 μm.

20. The method according to claim 11, wherein the melt index of the barrier coating layer is below 30 g/10 min.

21. (canceled)

22. The method according to claim 11, wherein the barrier coating layer comprises at least 10 wt-% of microcrystalline cellulose and at least 50 wt-% of polybutylene succinate, polybutylene adipate or combinations thereof, calculated from the total weight of the barrier coating layer.

23. The method according to claim 11, wherein the extrusion is performed on a moving web.

24-25. (canceled)
